(19) United States
(12) Patent Application Publication
(10) Pub. No.: US 2025/0129255 A1
(43) Pub. Date: Apr. 24, 2025

(54) CONDUCTIVE COMPOSITION, CONDUCTOR, AND ELECTRODE AND ELECTRONIC DEVICE INCLUDING CONDUCTOR

(71) Applicant: UNIST (ULSAN NATIONAL INSTITUTE OF SCIENCE AND TECHNOLOGY ), Ulsan (KR)

(72) Inventors: BongSoo KIM, Ulsan (KR); Wanho CHO, Ulsan (KR)

(73) Assignee: UNIST (ULSAN NATIONAL INSTITUTE OF SCIENCE AND TECHNOLOGY ), Ulsan (KR)

(21) Appl. No.: 18/833,623

(22) PCT Filed: Mar. 3, 2022
(86) PCT No.: PCT/KR2022/002973

§ 371 Date: Jul. 26, 2024

(30) Foreign Application Priority Data
Jan. 27, 2022 (KR) 10-2022-0012594

(51) Int. Cl. C09D 5/24; C08K 9/04; C09D 7/40; C09D 7/62

(52) U.S. Cl. CPC C09D 5/24; C09D 7/62; C09D 7/70; C08K 9/04; C08K 2201/001; C08K 2201/011

(57) ABSTRACT

Disclosed are a conductive composition including metal nanowires and a cross-linkable compound, a conductor, and an electrode and an electronic device, each including the conductor.

### TECHNICAL FIELD

The present disclosure relates to a conductive composition, a conductor, and an electrode and an electronic device each including the conductor.

### BACKGROUND ART

Metal oxides such as indium tin oxide (ITO) are widely used as electrodes, particularly, transparent electrodes, of electronic devices, and transparent electrodes using metal nanowires or metal grids, graphene, or carbon nanotubes have also been developed. Despite high electrical conductivity, there are limits to apply metal oxide-based transparent electrodes to flexible electronic devices, which are being developed recently, due to inflexibility and brittleness. Although metal nanowire or metal grid materials have advantages of high transmittance and low sheet resistance, there are problems such as high price and unavailability to perform large-scale patterning processes. Also, due to insufficient conductivity, carbon-based materials are applied to a narrow range of application.

As an alternative of transparent electrode materials, conductive polymer materials are being actively developed. Although poly(3,4-ethylenedioxythiophene):polystyrenesulfonic acid (PEDOT:PSS) is a commercially available material at present, PEDOT:PSS has lower electrical conductivity than that of ITO electrodes and very low stability against air/humidity. There is a need for research into organic materials to solve these electrical conductivity and stability challenges.

### DISCLOSURE

### Technical Problem

Provided are a conductive composition and a conductor, the conductive composition being capable of forming a conductor enabling pattern formation and having excellent conductivity and reduced surface roughness. Provided also are an electrode and an electronic device, each having excellent electrical and physical properties by using the conductor.

### Technical Solution

According to an aspect, a conductive composition includes metal nanowires and a cross-linkable compound.

According to an embodiment, the cross-linkable compound may be represented by Formula 1 below:

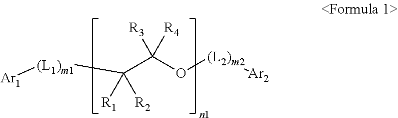

wherein in Formula 1,
L₁ and L₂ may each independently be a single bond, —C═O—, a substituted or unsubstituted C₁-C₃₀ alkylene group, a substituted or unsubstituted C₂-C₃₀ alkenylene group, or a substituted or unsubstituted C₂-C₃₀ alkynylene group,
m1 and m2 may each independently be 0, 1, 2 or 3,
Ar₁ and Ar₂ may each independently be a substituted or unsubstituted C₅-C₆₀ carbocyclic group, or a substituted or unsubstituted C₁-C₆₀ heterocyclic group,
Ar₁ and Ar₂ may each independently be substituted with at least one cross-linkable group,
n1 may be an integer from 2 to 300,000,
R₁ to R₄ may each independently be hydrogen, deuterium, —F, —Cl, —Br, —I, a hydroxyl group, a cyano group, a substituted or unsubstituted C₁-C₃₀ alkyl group, a substituted or unsubstituted C₂-C₃₀ alkenyl group, a substituted or unsubstituted C₂-C₃₀ alkynyl group, a substituted or unsubstituted C₁-C₃₀ alkoxy group, a substituted or unsubstituted C₁-C₃₀ alkylthio group, —Si(Q₁)(Q₂)(Q₃), a substituted or unsubstituted C₅-C₆₀ carbocyclic group, or a substituted or unsubstituted C₁-C₆₀heterocyclic group,
at least one of the substituted C₁-C₃₀ alkylene group, the substituted C₂-C₃₀ alkenylene group, the substituted C₂-C₃₀ alkynylene group, the substituted C₅-C₆₀ carbocyclic group, the substituted C₁-C₆₀ heterocyclic group, the substituted C₁-C₃₀ alkyl group, the substituted C₂-C₃₀ alkenyl group, the substituted the substituted C₂-C₃₀ alkynyl group, the substituted C₁-C₃₀ alkoxy group, and the substituted C₁-C₃₀ alkylthio group may be deuterium, —F, —Cl, —Br, —I, a hydroxyl group, a cyano group, a C₁-C₃₀ alkyl group, a C₂-C₃₀ alkenyl group, a C₂-C₃₀ alkynyl group, a C₁-C₃₀ alkoxy group, a C₁-C₃₀ alkylthio group, or —Si(Q₁₁)(Q₁₂)(Q₁₃), and
Q₁₁ to Q₁₃ may each independently be hydrogen, deuterium, —F, —Cl, —Br, —I, a hydroxyl group, a cyano group, a C₁-C₃₀ alkyl group, a C₂-C₃₀ alkenyl group, a C₂-C₃₀ alkynyl group, a C₁-C₃₀ alkoxy group, or a C₁-C₃₀ alkylthio group.

According to an aspect, a conductor includes a conductive layer including metal nanowires and a cross-linkable compound.

According to an aspect, an electrode includes the conductor.

According to an aspect of the present disclosure, an electronic device includes the conductor.

### Advantageous Effects

The conductor formed by using the conductive composition includes a cross-linkable compound, thereby having excellent conductivity and stability and improved surface roughness and enabling formation of high-resolution patterns.

### DESCRIPTION OF DRAWINGS

FIGS. 1 and 2 each schematically illustrate an example of a conductor according to an embodiment.

FIG. 3 is a cross-sectional view schematically illustrating an example of an electronic device according to an embodiment.

FIGS. 4 and 5 each show results of a stability test performed on electronic devices of a comparative example and an example.

### BEST MODE

Hereinafter, the present disclosure will be described in more detail.

Throughout the specification, it is to be understood that the terms “include” or “have” are intended to indicate the existence of elements disclosed in the specification, and are not intended to preclude the possibility that one or more other elements may exist or may be added.

As used herein, when one element such as layer and film is referred to as being “on” another element, it may be “directly on” the other element, or intervening elements may also be present therebetween.

### [Conductive Composition]

A conductive composition provided according to an embodiment of the present disclosure includes metal nanowires and a cross-linkable compound.

According to an embodiment, the metal nanowires may include gold (Au), silver (Ag), copper (Cu), nickel (Ni), aluminum (AI), platinum (Pt), palladium (Pd), cobalt (Co), tin (Sn), lead (Pb), or an alloy thereof.

According to an embodiment, the metal nanowires may be silver nanowires (AgNWs).

According to an embodiment, the metal nanowires may have a major axis length:diameter ratio of 5:1 or more, for example, 10:1 or more.

According to an embodiment, the metal nanowires may have a major axis length of 0.1 μm to 30 μm and a diameter of 5 nm to 250 nm, for example, 10 nm to 150 nm. In the case where the above-mentioned range is satisfied, a scattering effect by the metal nanowires may decrease to increase transmittance of the conductive layer formed by using the conductive composition and also durability may be improved.

According to an embodiment, the cross-linkable compound may be represented by Formula 1 below:

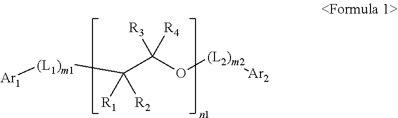

wherein in Formula 1,
L₁ and L₂ may each independently be a single bond, —C═O—, a substituted or unsubstituted C₁-C₃₀ alkylene group, a substituted or unsubstituted C₂-C₃₀ alkenylene group, or a substituted or unsubstituted C₂-C₃₀ alkynylene group,
m1 and m2 may each independently be 0, 1, 2 or 3,
Ar₁ and Ar₂ may each independently be a substituted or unsubstituted C₅-C₆₀ carbocyclic group or a substituted or unsubstituted C₁-C₆₀ heterocyclic group,
Ar₁ and Ar₂ may each independently be substituted with at least one cross-linkable group,
n1 may be an integer from 2 to 300,000,
R₁ to R₄ may each independently be hydrogen, deuterium, —F, —Cl, —Br, —I, a hydroxyl group, a cyano group, a substituted or unsubstituted C₁-C₃₀ alkyl group, a substituted or unsubstituted C₂-C₃₀ alkenyl group, a substituted or unsubstituted C₂-C₃₀ alkynyl group, a substituted or unsubstituted C₁-C₃₀ alkoxy group, a substituted or unsubstituted C₁-C₃₀ alkylthio group, —Si(Q₁)(Q₂)(Q₃), a substituted or unsubstituted C₅-C₆₀ carbocyclic group, or a substituted or unsubstituted C₁-C₆₀ heterocyclic group,
at least one of the substituted C₁-C₃₀ alkylene group, the substituted C₂-C₃₀ alkenylene group, the substituted C₂-C₃₀ alkynylene group, the substituted C₅-C₆₀ carbocyclic group, the substituted C₁-C₆₀ heterocyclic group, the substituted C₁-C₃₀ alkyl group, the substituted C₂-C₃₀ alkenyl group, the substituted C₂-C₃₀ alkynyl group, the substituted C₁-C₃₀ alkoxy group, and the substituted C₁-C₃₀ alkylthio group may be deuterium, —F, —Cl, —Br, —I, a hydroxyl group, a cyano group, a C₁-C₃₀ alkyl group, a C₂-C₃₀ alkenyl group, a C₂-C₃₀ alkynyl group, a C₁-C₃₀ alkoxy group, a C₁-C₃₀ alkylthio group, or —Si(Q₁₁)(Q₁₂)(Q₁₃), and
Q₁₁ to Q₁₃ may each independently be hydrogen, deuterium, —F, —Cl, —Br, —I, a hydroxyl group, a cyano group, a C₁-C₃₀ alkyl group, a C₂-C₃₀ alkenyl group, a C₂-C₃₀ alkynyl group, a C₁-C₃₀ alkoxy group, or a C₁-C₃₀ alkylthio group.

According to an embodiment, the L₁ and L₂ may each independently be a single bond, —C═O— or a methylene group.

According to an embodiment, the m1 and m2 may each independently be 1 or 2.

According to an embodiment, Ar₁ and Ar₂ may each independently be a substituted or unsubstituted phenyl group, and may each independently be substituted with at least one cross-linkable group.

According to an embodiment, n1 may be an integer selected from 2 to 100,000.

According to an embodiment, n1 may be an integer selected from 2 to 50,000.

According to an embodiment, n1 may be an integer selected from 2 to 10,000.

According to an embodiment, n1 may be an integer selected from 2 to 5,000.

According to an embodiment, n1 may be an integer selected from 2 to 1,000.

According to an embodiment, n1 may be an integer selected from 2 to 500.

According to an embodiment, n1 may be an integer selected from 2 to 200.

According to an embodiment, n1 may be an integer selected from 2 to 100.

According to an embodiment, n1 may be an integer selected from 2 to 24.

According to an embodiment, n1 may be an integer selected from 2 to 20.

According to an embodiment, n1 may be an integer selected from 4 to 16.

According to an embodiment, cross-linkable group may be an azide group (—N₃), a sulfur-containing group, or a unsaturated double bond-containing group.

According to an embodiment, the cross-linkable group may be an azide group.

According to an embodiment, the cross-linkable compound may be represented by Formula 2 below:

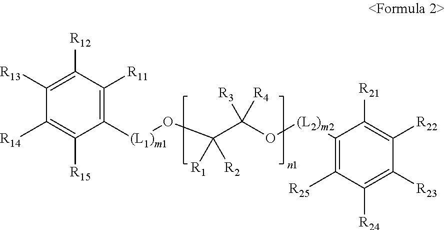

wherein in Formula 2,
L₁, L₂, m1, m2, n1 and R₁ to R₄ are as described above,
R₁₁ to R₁₅ and R₂₁ to R₂₅ may each independently be a cross-linkable group, hydrogen, deuterium, —F, —Cl, —Br, —I, a hydroxyl group, a cyano group, a substituted or unsubstituted C₁-C₃₀ alkyl group, a substituted or unsubstituted C₂-C₃₀ alkenyl group, a substituted or unsubstituted C₂-C₃₀ alkynyl group, a substituted or unsubstituted C₁-C₃₀ alkoxy group, a substituted or unsubstituted C₁-C₃₀ alkylthio group, —Si(Q₁)(Q₂)(Q₃), a substituted or unsubstituted C₅-C₆₀ carbocyclic group, or a substituted or unsubstituted C₁-C₆₀ heterocyclic group,
at least one of R₁₁ to R₁₅ may be a cross-linkable group, and
at least one of R₂₁ to R₂₅ may be a cross-linkable group.

According to an embodiment, one of R₁₁ to R₁₅ may be an azide group and the others may each be —F.

According to an embodiment, one of R₂₁ to R₂₅ may be an azide group and the others may each be —F.

According to an embodiment, the cross-linkable compound may be represented by Formula 3 below:

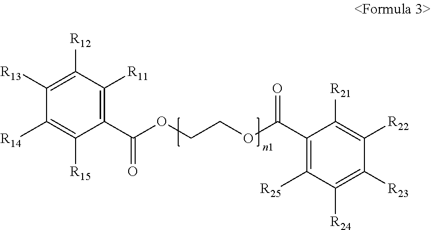

wherein in Formula 3,
n1, R₁₁ to R₁₅ and R₂₁ to R₂₅ are as described above.

According to an embodiment, the cross-linkable compound may be selected from Compounds 1 to 5 below.

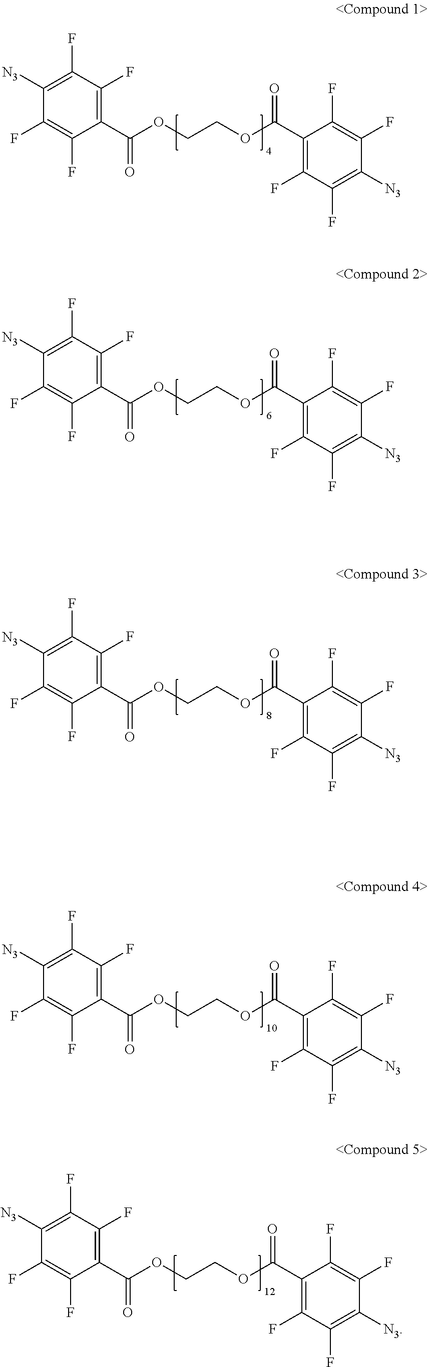

The cross-linkable compound may satisfy the structure of Formula 1, and may include a repeating unit represented by Formula E below.

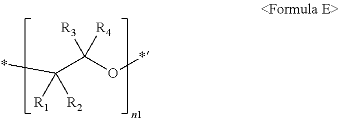

In Formula E,
R₁ to R₄ and n1 are as described above, and
* and *′ are binding sites with neighboring atoms.

The repeating unit included in the cross-linkable compound and represented by Formula E may provide an ion-conductive site for an adjacent salt, and accordingly, ionic conductivity of a product may be maintained or improved in a cross-linking reaction using the cross-linkable compound. In addition, by controlling the number of the repeating units, ionic conductivity of the cross-linking reaction product may be controlled.

Because the conductive composition according to an embodiment includes the cross-linkable compound, cross-links may be formed between the metal nanowires. Therefore, conductivity and stability of the composition may be improved. In addition, in the case where a conductor is formed by using the conductive composition, the conductor may have excellent conductivity and stability and improved surface roughness, thereby having excellent electrical and physical properties.

In addition, the conductive composition according to an embodiment may easily form a pattern of a metal nanowire conductive layer during formation of a conductor by controlling conditions for forming cross-links of the cross-linkable compound. For example, in the case where the cross-linkable compound includes an azide group as a cross-linkable group, by exposing only a portion of the conductive composition to light, a conductive layer is patterned to include metal nanowires only in the exposed portion.

According to an embodiment, the metal nanowire may include a hydrophilic capping layer formed on at least one portion of the surface.

According to an embodiment, the hydrophilic capping layer on the surface of the metal nanowire may be formed of polyvinylpyrrolidone (PVP), polyethyleneoxide, ethanol, an amine compound, a carboxyl compound, a thiol compound, or a combination thereof.

According to an embodiment, the hydrophilic capping layer on the surface of the metal nanowire may be formed of a surfactant such as sodium dodecyl sulfate (SDS) and cetyl trimethyl ammonium bromide (CTAB).

In the conductive composition according to an embodiment, the cross-linkable compound may form cross-links with compounds included in the hydrophilic capping layer on the surfaces of the metal nanowires.

### [Conductor]

According to another aspect of the present disclosure, provided is a conductor including a conductive layer including metal nanowires and a cross-linkable compound.

The conductor according to an embodiment may have a structure in which the metal nanowires are cross-linked by the cross-linkable compound. As cross-links are formed in this manner, the conductor may have excellent conductivity and stability and improved surface roughness, thereby having excellent electrical and physical properties.

According to an embodiment, the conductor may further include a substrate and the conductive layer may be disposed on the substrate.

The substrate may be selected in consideration of mechanical strength, thermal stability, surface smoothness, ease of handling, and waterproofness, and may be a silicon wafer, a glass substrate, a plastic film such as polyethersulfone, polyacrylate, polyetherimide, polyimide, polyethylene naphthalate, and polyethylene terephthalate, or a glass substrate coated with the plastic film.

According to an embodiment, the substrate may have a single-layer or multi-layer structure.

For example, the substrate may be a single layer including a resin. As another example, the substrate may have a multi-layer structure including two or more layers each including two or more different resins. As another example, the substrate may have a multi-layer structure including a resin-containing layer and a functional layer, and the functional layer may be, for example, an adhesive layer, an anti-corrosion layer, an anti-reflection layer, a hard coating layer, or a combination thereof.

According to an embodiment, the substrate included in the conductor may be transparent. For example, the substrate may have a visible light transmittance of 75% or more.

According to an embodiment, the substrate may have a visible light transmittance of 80% to 100%, for example, 85% to 99%, or 80% to 98%.

According to an embodiment, at least one portion of the surface of the substrate may be a self-assembly monolayer (SAM).

According to an embodiment, self-assembling molecules constituting the self-assembly monolayer may be a silane compound, a thiol compound, or any combination thereof.

According to an embodiment, the self-assembling molecules may be a silane compound substituted with a C₁-C₃₀ alkyl group or a C₁-C₃₀ alkoxy group.

According to an embodiment, the self-assembling molecules may be octadecylchlorosilane (ODTS).

In the conductor according to an embodiment, the cross-linkable compound may form cross-links with the metal nanowires and/or the compounds included in the hydrophilic capping layer on the surfaces of the metal nanowires and the substrate and/or the self-assembling molecules included in the self-assembly monolayer on the surface of the substrate. By the cross-links formed between the substrate and the conductive layer, the conductor may have excellent conductivity and stability and improved surface roughness, thereby having excellent electrical and physical properties, and also the conductor may have high resolution and excellent stability of a pattern.

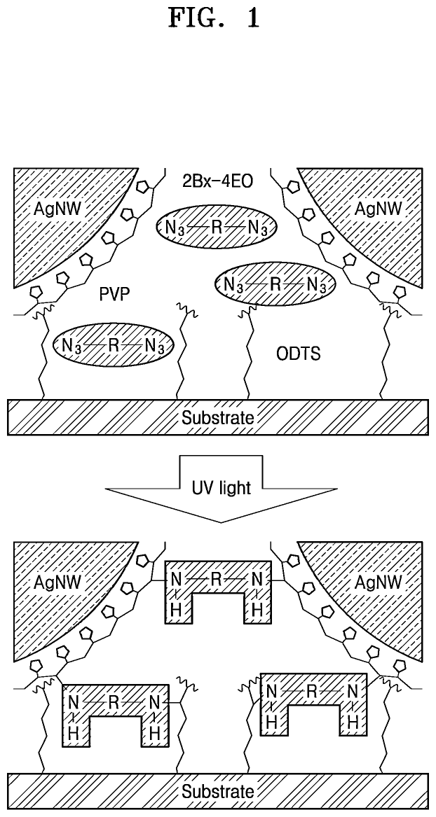

FIG. 1 schematically illustrates an example of a structure of a conductor according to an embodiment of the present disclosure. In FIG. 1, N₃—R—N₃ refers to a cross-linkable compound of Compound 1, and FIG. 1 exemplarily shows that the cross-linkable compound cross-links PVPs of the hydrophilic capping layer formed on the metal nanowires AgNWs or cross-links ODTS that is a self-assembly monolayer on the surface of the substrate with PVP by exposure to ultraviolet light (UV light). However, the structure of the conductor shown in FIG. 1 is merely an examples of the structure of the conductor according to an embodiment of the present disclosure, and the metal nanowires, the cross-linkable compound, the hydrophilic capping layer, the self-assembly monolayer on the surface of the substrate, and the like are not limited to those shown in FIG. 1.

According to an embodiment, the conductor may further include a conductive polymer.

According to an embodiment, the conductive polymer may be polyphenylene, poly(fluorene), polypyrene, polyazulene, polynaphthalene, poly(pyrrole), polycarbazole, polyindole, polyazepine, polyaniline, polythiophene, poly(3,4-ethylenedioxythiophene) (PEDOT), poly(p-phenylene sulfide) (PPS), poly(acetylene), poly(p-phenylene vinylene), or any combination thereof.

For example, the conductive polymer may be PEDOT:PSS.

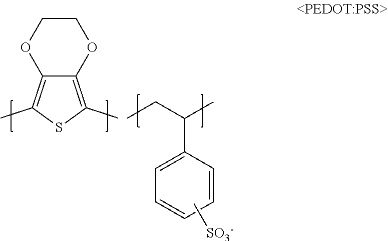

According to an embodiment, the conductive polymer may be included in the conductive layer.

According to an embodiment, the conductor may further include a coating layer disposed on the conductive layer, and the coating layer may include the conductive polymer.

In the case where the conductor according to an embodiment further includes the coating layer formed on the conductive layer, the coating layer may reinforce the surfaces of the metal nanowires included in the conductive layer to reduce surface roughness of the conductor and further improve conductivity and stability.

Also, referring to FIG. 2, the conductor according to an embodiment may be formed by pattering the conductive layer as described above. In this case, wettability of a portion where the conductive layer is formed is different from that of a portion where the conductive layer is not formed, so that the coating layer may be selectively formed on the portion where the conductive layer is formed. Therefore, the conductor according to an embodiment an embodiment may have further improved resolution and stability of the pattern.

A method of manufacturing a conductor according to an embodiment is not particularly limited.

According to an embodiment, the conductor may be formed of the conductive composition including the metal nanowires and the cross-linkable compound.

For example, the conductor may be formed by forming a conductive layer by depositing the conductive composition including the metal nanowires and the cross-linkable compound on the substrate, or by coating the composition via a solution process. For example, the conductor may be manufactured by thermal deposition, vacuum deposition, laser deposition, spin coating, spray coating, casting, drop casting, dipping, Langmuir-Blodgett (LB), inkjet printing, screen printing, laser printing, imprinting, laser induced thermal imaging (LITI), or the like.

According to an embodiment, the method of manufacturing a conductor may further include heat treatment after the deposition or coating, and thus density and uniformity of the conductive layer may further be improved. The heat treatment may be appropriately selected in consideration of an organic semiconductor compound and a solvent commonly used in the art by a person skilled, for example, may be performed at 60° C. to 300° C. for 1 minute to 2 hours.

According to an embodiment, the method of manufacturing a conductor may further include forming a pattern on the conductive layer.

For example, the method of manufacturing a conductor may further include exposing at least one portion of the conductive composition to ultraviolet light (UV); and forming a pattern by developing the UV-exposed conductive composition.

The process of forming the pattern is a process of removing a portion that is not cross-linked by exposure to UV light by using a developing solvent, and thereby a conductor having a high-resolution pattern may be obtained.

As the developing solvent, any solvent capable of dissolving the portion not cross-linked by the exposure to UV light.

According to an embodiment, the developing solvent may be isopropyl alcohol (IPA) or dimethylformamide (DMF).

According to an embodiment, the conductive layer may be formed on the substrate by patterning.

According to an embodiment, the conductor may be transparent.

According to an embodiment, the conductor may have a visible light transmittance of 80% to 100%. For example, the conductor may have a visible light transmittance of 85% to 99%, or 80% to 98%.

### [Electrode]

According to another embodiment of the present disclosure, provided is an electrode including the conductor.

According to an embodiment, the electrode may be a transparent electrode.

For example, the electrode may have a visible light transmittance of 80% to 100%, 85% to 99%, or 80% to 98%.

According to an embodiment, the electrode may be used in the manufacture of an electrode, e.g., transparent electrode, of an electronic device.

For descriptions of the electrode according to an embodiment of the present disclosure, refer to descriptions of a first electrode and/or a second electrode of an electronic device which will be described below.

### [Electronic Device]

According to another embodiment of the present disclosure, provided is an electronic device including the conductor.

According to an embodiment, the conductor may be used in an electrode of the electronic device.

According to an embodiment, the electronic device may be an organic thin film transistor (OTFT), an organic electrochromic device (EC), an organic light emitting diode (OLED), an organic solar cell (OSC), or an organic photodiode (OPD).

According to an embodiment, the electronic device is an organic thin film transistor.

For example, the electronic device may be an organic thin film transistor having a bottom-gate/bottom-contact (BGBC) structure, and the organic thin film transistor may include: a substrate; a gate electrode formed on the substrate; a gate insulating layer formed on the gate electrode; an organic semiconductor thin film formed on the gate insulating layer; and a source electrode and a drain electrode formed on the organic semiconductor thin film.

Alternatively, for example, the electronic device may be an organic thin film transistor having a top-gate/bottom-contact (TGBC) structure, and the organic thin film transistor may include: a substrate; a source electrode and a drain electrode formed on the substrate; an organic semiconductor thin film formed on the source electrode and the drain electrode and including an organic semiconductor compound; a gate insulating layer formed on the organic semiconductor thin film; and a gate electrode formed on the gate insulating layer.

Each of the source electrode, the drain electrode, and the gate electrode may have a single-layer structure as a single layer or a multilayer structure including a plurality of layers and may include a metal commonly used in organic thin film transistors (e.g., Au, Al, Ag, Mg, Ca, Yb, Cs-ITO, and an alloy thereof) or metal particles, a carbonaceous material (nanotubes, graphene, and the like), or a conductive polymeric material (PEDOT:PSS, PAN, and the like).

According to an embodiment, the source electrode and the drain electrode may include gold (Au).

According to an embodiment, the gate electrode may include silver (Au), for example, silver nanowires (AgNW).

According to an embodiment, at least one of the source electrode, the drain electrode, and the gate electrode may include the conductor.

The gate insulating layer may have a single-layer structure as a single layer or a multilayer structure including a plurality of layers and any insulator with high permittivity commonly used in organic thin film transistors may be used.

For example, the gate insulating layer may include an organic material such as a polyvinyl alcohol-based compound, a polyimide-based compound, a polyacryl-based compound, a polystyrene-based compound, and benzocyclobutane (BCB), an inorganic material such as silicon nitride (SiNₓ), aluminum oxide (Al₂O₃), and silicon oxide (SiO₂), or any combination thereof. Alternatively, the gate insulating layer may include various ionic liquids and insulating polymers.

For example, the electronic device may be an organic electrochemical transistor (OECT) or an organic field-effect transistor (OFET).

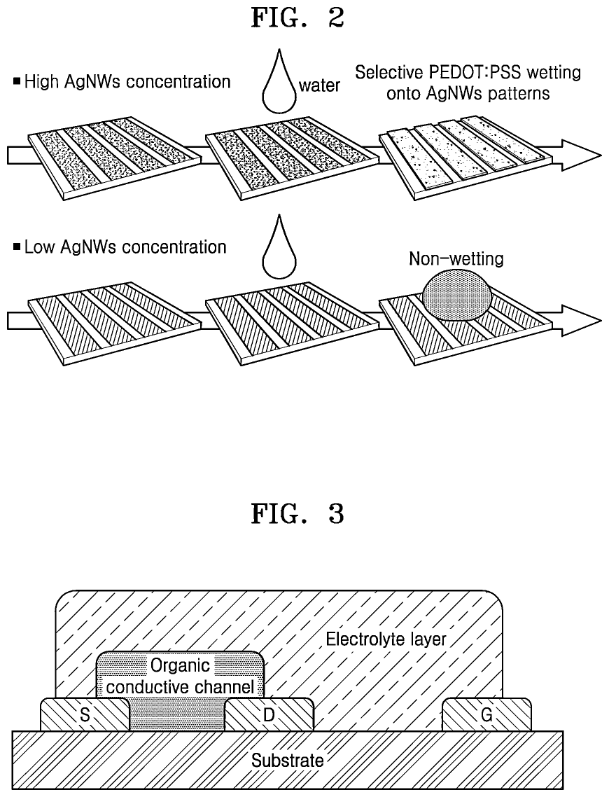

Referring to FIG. 3, the electronic device may be an organic electrochemical transistor, and the organic electrochemical transistor may include: a substrate; a source electrode S and a drain electrode D formed on the substrate; an organic conductive channel formed on the substrate and in electrical contact with the source electrode and the drain electrode; an electrolyte layer formed on the organic conductive channel; and a gate electrode G formed on the electrolyte layer.

The source electrode, the drain electrode, and the gate electrode are as described in the specification.

According to an embodiment, at least one of the source electrode, the drain electrode, and the gate electrode of the organic electrochemical transistor may include the conductor.

The organic conductive channel may include an organic semiconductor compound.

For example, the organic conductive channel may include a conductive polymer.

The electrolyte layer may include an electrolyte in the form of liquid or gel.

According to an embodiment, the electrolyte layer may include an ionic polymer and an ionic liquid.

As the ionic polymer, for example, poly(methyl methacrylate) (PMMA), polyethylene glycol diacrylate (PEGDA), polydimethylsiloxane, and polyurethane may be used.

According to an embodiment, the ionic liquid may be a nitrogen-containing ionic liquid, a phosphorus (P)-containing ionic liquid, or any combination thereof.

According to an embodiment, the ionic liquid may include a cation and an anion,
wherein the cation may be an ammonium ion, an imidazolium ion, a piperidinium ion, a pyrrolidium ion, a phosphonium ion, or any combination thereof, and
the anion may be a halogen ion, an acetate ion (CH₃CO₂⁻), a nitrate ion (NO₃⁻), a tetrafluoroborate ion (BF₄⁻), a hexafluorophosphate ion (PF₆⁻), a trifluoromethane sulfonate ion (Tf⁻), a bis((trifluoromethyl)sulfonyl)imide ion (TFSI⁻), or any combination thereof.

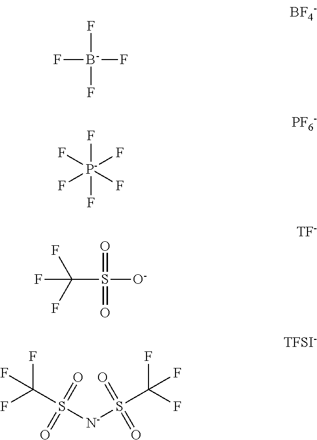 [SMILES: F[B-](F)(F)F ; F[P-](F)(F)(F)(F)F ; O=S(=O)([O-])C(F)(F)F ; O=S(=O)([N-]S(=O)(=O)C(F)(F)F)C(F)(F)F]

According to an embodiment, the ionic liquid may be 1-ethyl-3-methylimidazolium bis(trifluoromethylsulfonyl)imide [EMIM][TFSI].

However, the structure of the electronic device of the present disclosure is not limited to that shown in FIG. 3, and may be any structure commonly used in the art according to the type of the electronic device.

According to an embodiment, the electronic device may be a flexible electronic device.

According to an embodiment, the electronic device may be a stretchable electronic device.

As used herein, the C₅-C₆₀ carbocyclic group refers to a monocyclic or polycyclic group having 5 to 60 carbon atoms including only carbon as a ring-forming atom. The C₅-C₆₀ carbocyclic group may be an aromatic carbocyclic group or a non-aromatic carbocyclic group. The C₅-C₆₀ carbocyclic group may be a ring such as benzene, a monovalent group such as a phenyl group, or a divalent group such as a phenylene group. Alternatively, the C₅-C₆₀ carbocyclic group may be modified in various ways, and may be, for example, a trivalent group or a tetravalent group, according to the number of substituents connected to the C₅-C₆₀ carbocyclic group.

As used herein, the C₁-C₆₀ heterocyclic group refers to a group having the same structure as the C₅-C₆₀ carbocyclic group except that at least one hetero atom selected from N, O, Si, P, and S as well as carbon (1 to 60 carbon atoms) is used as a ring-forming atom.

As used herein, the C₁-C₃₀ alkyl group refers to a linear or branched aliphatic hydrocarbon group including 1 to 30 carbon atoms, and examples thereof may include a methyl group, an ethyl group, a propyl group, an isobutyl group, a sec-butyl group, a ter-butyl group, a pentyl group, an iso-amyl group, a hexyl group, a heptyl group, a n-octyl group, and a 2-ethylhexyl group.

As used herein, the C₂-C₃₀ alkenyl group refers to a hydrocarbon group including at least one carbon-carbon double bond in the middle of or at the end of the C₂-C₃₀ alkyl group, and examples thereof may include an ethenyl group, a propenyl group, and a butenyl group.

As used herein, the C₂-C₃₀ alkynyl group refers to a hydrocarbon group including at least one carbon-carbon triple bond in the middle of or at the end of the C₂-C₃₀ alkyl group, and examples thereof may include an ethynyl group and a propynyl group.

As used herein, the C₁-C₃₀ alkoxy group refers to a monovalent group having a formula —OA₁₀₁ (wherein A₁₀₁ is the C₁-C₃₀ alkyl group), and examples thereof may include a methoxy group, an ethoxy group, and an isopropyloxy group.

As used herein, the C₁-C₃₀ alkylthio group refers to a monovalent group having a formula —SA₁₀₁ (wherein A₁₀₁ is the C₁-C₃₀ alkyl group), and examples thereof may include a methylthio group, an ethylthio group, and an isopropylthio group.

As used herein, * and *′ are binding sites with neighboring atoms in the corresponding formulae unless otherwise defined.

Hereinafter, the present disclosure will be described in more detail with reference to the following examples. However, the following examples are merely presented by exemplifying the present disclosure, and the scope of the present disclosure is not limited thereto.

### MODE FOR INVENTION

### Examples

### Example 1: Preparation of Cross-Linked AgNW Conductor

AgNWs dispersed in IPA were purchased from SG Flexio Co. and used in the manufacture of a conductor. The AgNWs had a length of 18 μm to 24 μm and a diameter of 17 nm to 27 nm.

A glass substrate was sonicated with acetone, isopropylalcohol, and deionized water for 20 minutes each. Subsequently, the surface of the substrate was modified with ODTS (Gelest, Inc.).

An AgNW solution (5 mg mL⁻¹) to which 3 wt % Compound 1 was added was applied onto the substrate treated with hydrophobic ODTS by using a Mayer rod (#14) to form a conductive layer. UV light (wavelength: 254 nm, power: 1000 W·cm⁻²) was applied sequentially to the coated AgNW network for 5 seconds by using a photo mask. While areas exposed to UV light were cross-linked, non-exposed areas of the AgNWs were developed by dipped in an IPA solvent. The formed AgNW pattern was thermally welded on a hot plate at 150° C. for 10 minutes.

A PEDOT:PSS solution (CLEVIOSTM, PH 1000) mixed with DMSO (Sigma Aldrich, 5 vol %) was applied by spin-coating onto the photo-patterned AgNW network. The resultant was annealed on a hot plate at 150° C. for 2 minutes under ambient conditions to remove the residual solvent, thereby preparing a cross-linked AgNW conductor.

### Comparative Example 1: Preparation of AgNW Conductor

An AgNW conductor was prepared in the same manner as in Example 1, except that Compound 1 was not used in the formation of the conductive layer.

### Evaluation Example 1: Evaluation of Stability of AgNW Conductor

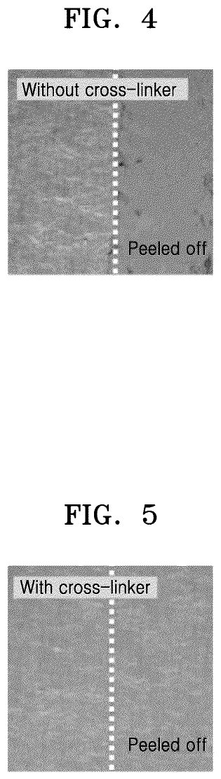

Surfaces of the AgNW conductors prepared in Example 1 and Comparative Example 1 were observed after a polyimide tape was attached to and detached from the conductors. Evaluation results of the AgNW conductor of Comparative Example 1 are shown in FIG. 4 and evaluation results of the AgNW conductor of Example 1 are shown in FIG. 5.

Referring to FIGS. 4 and 5, while less surface change was observed and the AgNW network was maintained in the AgNW conductor of Example 1 when compared before and after attachment and detachment of the polyimide tape, greater difference was observed in the AgNW conductor of Comparative Example 1 when compared before and after attachment and detachment of the polyimide tape because the AgNWs were damaged after the attachment and detachment of the tape. Therefore, the conductor according to an embodiment had excellent stability.

Although the present disclosure have been described with reference to the embodiments, it would be appreciated by those having ordinary skill in the art that changes and modifications may be made in these embodiments without departing from the principles and spirit of the present disclosure. Therefore, the spirit and scope of the present disclosure are defined in the following claims.

1: A conductive composition comprising metal nanowires and a cross-linkable compound.

2: The conductive composition of claim 1, wherein the cross-linkable compound is represented by Formula 1 below: 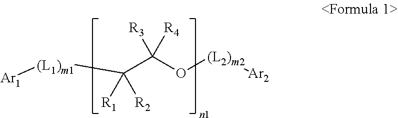
wherein in Formula 1,
L₁ and L₂ are each independently a single bond, —C═O—, a substituted or unsubstituted C₁-C₃₀ alkylene group, a substituted or unsubstituted C₂-C₃₀ alkenylene group, or a substituted or unsubstituted C₂-C₃₀ alkynylene group,
m1 and m2 are each independently 0, 1, 2 or 3,
Ar₁ and Ar₂ are each independently a substituted or unsubstituted C₅-C₆₀ carbocyclic group or a substituted or unsubstituted C₁-C₆₀ heterocyclic group,
Ar₁ and Ar₂ are each independently substituted with at least one cross-linkable group,
n1 is an integer from 2 to 300,000,
R₁ to R₄ are each independently hydrogen, deuterium, —F, —Cl, —Br, —I, a hydroxyl group, a cyano group, a substituted or unsubstituted C₁-C₃₀ alkyl group, a substituted or unsubstituted C₂-C₃₀ alkenyl group, a substituted or unsubstituted C₂-C₃₀ alkynyl group, a substituted or unsubstituted C₁-C₃₀ alkoxy group, a substituted or unsubstituted C₁-C₃₀ alkylthio group, —Si(Q₁)(Q₂)(Q₃), a substituted or unsubstituted C₅-C₆₀ carbocyclic group, or a substituted or unsubstituted C₁-C₆₀ heterocyclic group,
at least one of the substituted C₁-C₃₀ alkylene group, the substituted C₂-C₃₀ alkenylene group, the substituted C₂-C₃₀ alkynylene group, the substituted C₅-C₆₀ carbocyclic group, the substituted C₁-C₆₀ heterocyclic group, the substituted C₁-C₃₀ alkyl group, the substituted C₂-C₃₀ alkenyl group, the substituted C₂-C₃₀ alkynyl group, the substituted C₁-C₃₀ alkoxy group, and the substituted C₁-C₃₀ alkylthio group is deuterium, —F, —Cl, —Br, —I, a hydroxyl group, a cyano group, a C₁-C₃₀ alkyl group, a C₂-C₃₀ alkenyl group, a C₂-C₃₀ alkynyl group, a C₁-C₃₀ alkoxy group, a C₁-C₃₀ alkylthio group, or —Si(Q₁₁)(Q₁₂)(Q₁₃), and
Q₁₁ to Q₁₃ are each independently hydrogen, deuterium, —F, —Cl, —Br, —I, a hydroxyl group, a cyano group, a C₁-C₃₀ alkyl group, a C₂-C₃₀ alkenyl group, a C₂-C₃₀ alkynyl group, a C₁-C₃₀ alkoxy group, or a C₁-C₃₀ alkylthio group.

3: The conductive composition of claim 2, wherein the cross-linkable group is an azide group (—N₃), a sulfur-containing group, or a unsaturated double bond-containing group.

4: The conductive composition of claim 2, wherein the cross-linkable compound is represented by Formula 2 below: 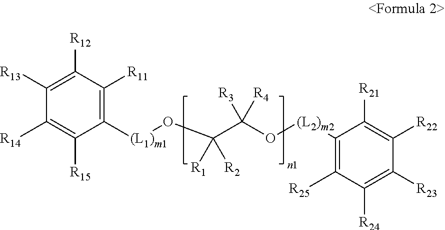
wherein in Formula 2,
L₁, L₂, m1, m2, n1 and R₁ to R₄ are as described above in claim 2,
R₁₁ to R₁₅ and R₂₁ to R₂₅ are each independently a cross-linkable group, hydrogen, deuterium, —F, —Cl, —Br, —I, a hydroxyl group, a cyano group, a substituted or unsubstituted C₁-C₃₀ alkyl group, a substituted or unsubstituted C₂-C₃₀ alkenyl group, a substituted or unsubstituted C₂-C₃₀ alkynyl group, a substituted or unsubstituted C₁-C₃₀ alkoxy group, a substituted or unsubstituted C₁-C₃₀ alkylthio group, —Si(Q₁)(Q₂)(Q₃), a substituted or unsubstituted C₅-C₆₀ carbocyclic group, or a substituted or unsubstituted C₁-C₆₀ heterocyclic group,
at least one of R₁₁ to R₁₅ is a cross-linkable group, and
at least one of R₂₁ to R₂₅ is a cross-linkable group.

5: The conductive composition of claim 4, wherein one of R₁₁ to R₁₅ is an azide group, and the others are each —F or —Cl, and
one of R₂₁ to R₂₅ is an azide group, and the others are each —F or —Cl.

6: The conductive composition of claim 2, wherein the cross-linkable compound is selected from Compounds 1 to 5 below:

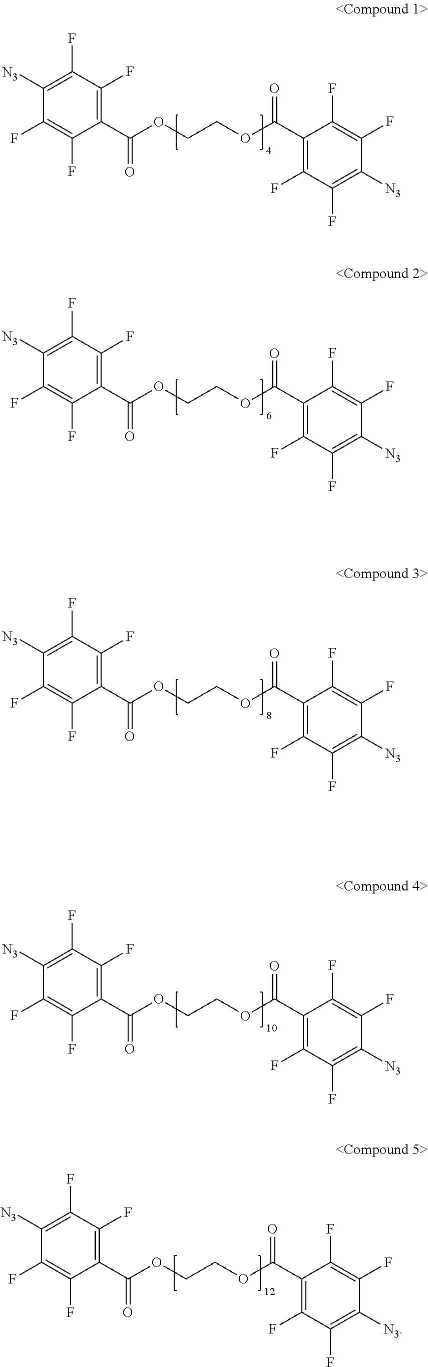

7: The conductive composition of claim 1, wherein the metal nanowire has a hydrophilic capping layer formed on at least one portion of a surface thereof, and
the hydrophilic capping layer is formed of polyvinylpyrrolidone (PVP), polyethyleneoxide, ethanol, an amine compound, a carboxyl compound, a thiol compound, or a combination thereof, or formed of a surfactant including sodium dodecyl sulfate (SDS) or cetyl trimethyl ammonium bromide (CTAB).

8: The conductive composition of claim 7, wherein the cross-linkable compound forms cross-links with the compounds included in the hydrophilic capping layer.

9: A conductor comprising a conductive layer including metal nanowires and a cross-linkable compound.

10: The conductor of claim 9, further comprising a substrate, wherein the conductive layer is disposed on the substrate.

11: The conductor of claim 10, wherein at least one portion of a surface of the substrate is a self-assembly monolayer (SAM), and
the cross-linkable compound forms cross-links between compounds included in a hydrophilic capping layer and self-assembling molecules included in the SAM.

12: The conductor of claim 9, further comprising a coating layer disposed on the conductive layer,
wherein the coating layer comprises a conductive polymer.

13: The conductor of claim 9, wherein the conductor has a visible light transmittance of 80% or more.

14: An electrode comprising the conductor of claim 9.

15: An electronic device comprising the conductor of claim 9.

16: The electronic device of claim 15, wherein the electronic device is one of an organic thin film transistor (OTFT), an organic electrochromic device (EC), an organic light emitting diode (OLED), an organic solar cell (OSC), and an organic photodiode (OPD).
